(19) United States
(12) Patent Application Publication
(10) Pub. No.: US 2022/0207981 A1
(43) Pub. Date: Jun. 30, 2022

(54) Alerting Operatives as to the Presence of a Hazard

(71) Applicant: Wearable Technology Limited, Leicester (GB)

(72) Inventors: Joanne Rebecca SAYERS, Leicester (GB); Neil John CARTER, Nuneaton (GB)

(21) Appl. No.: 17/553,991

(22) Filed: Dec. 17, 2021

(30) Foreign Application Priority Data
Dec. 24, 2020 (GB) 2020603.3

(51) Int. Cl. G08B 21/12; G08B 21/18

(52) U.S. Cl. CPC G08B 21/12; G08B 21/182

(57) ABSTRACT

A system is shown for alerting operatives as to the presence of a hazard, comprising a plurality of wearable items (101), each worn by a respective operative. Each wearable item has a detector (102) for detecting the presence of a hazardous attribute; a control unit (202) for receiving local hazard data from said detector; an alarm device (103) for conveying an alarm condition to the respective operative; a transmitter for transmitting said local hazard data to other operatives within an operational vicinity, where said local hazard data is received as remote hazard data; and a receiver for receiving remote hazard data transmitted from said other operatives. The control unit is configured to supply an alarm signal to the alarm device in response to evaluating the local hazard data in combination with the remote hazard data.

### CROSS REFERENCE TO RELATED APPLICATIONS

This application claims priority from United Kingdom Patent Application number 2020603.3, filed on Dec. 24, 2020, the whole contents of which are incorporated herein by reference.

### TECHNICAL FIELD

The present invention relates to a system for alerting operatives as to the presence of a hazard, comprising a plurality of wearable items, wherein each said wearable item is worn by a respective operative and each item has a detector for quantitatively detecting the presence of a potentially hazardous attribute.

The present invention also relates to a method of alerting operatives as to the presence of a hazard. The present invention also relates to an apparatus for inclusion within a wearable item.

### BACKGROUND OF THE INVENTION

It is known to provide wearable items with detectors for detecting hazards, such as gas concentrations, dust concentrations and concentrations of radiation etc. A local evaluation of concentrations may be made which, if exceeding a threshold, may result in the generation of an alarm signal. Locally, in response to this alarm signal being generated, indications may be provided to an operative in the form of flashing lights and audible sounds. In addition, as described in U.S. Pat. Nos. 9,922,519 and 10,497,244, assigned to the present applicant, it is also possible for alarm signals to be transmitted to other operatives and a different form of indication may be presented when a local hazard has been detected or a hazard detection has been transmitted from a remote operative working within the vicinity.

Although known systems produce alarm signals that improve overall safety, problems exist in terms of false positives being generated, possibly resulting in an unnecessary evacuation, along with the production of false negatives occurring, where a widespread low-level hazard may be ignored, effectively creating a false negative. There is also a move towards using less expensive detectors so that the detectors may be deployed more widely.

### BRIEF SUMMARY OF THE INVENTION

According to a first aspect of the present invention, there is provided a system for alerting operatives as to the presence of a hazard, comprising a plurality of wearable items, wherein each said wearable item is worn by a respective operative and each said wearable item comprises: a detector for detecting the presence of a hazardous attribute; a control unit for receiving local hazard data from said detector; an alarm device for conveying an alarm condition to the respective operative; a transmitter for transmitting said local hazard data to other operatives within an operational vicinity, where said local hazard data is received as remote hazard data; and a receiver for receiving remote hazard data transmitted from said other operatives, wherein: said control unit is configured to supply an alarm signal to said alarm device in response to evaluating said local hazard data in combination with said remote hazard data.

In an embodiment, said wearable items include a location device for generating local location data; said transmitter is configured to transmit said local location data to other operatives, where said local location data is received as remote location data; said receiver is configured to receive remote location data from said other operatives; said control unit is configured to calculate distances to said remote operatives based on said local location data and said remote location data; and said control unit is configured to evaluate said remote hazard data with reference to said calculated distances.

The remote hazard data may each be weighted by a respective calculated distance. A potential alarm signal based on a local hazardous attribute may be supressed if said remote hazard data indicates levels below a predetermined threshold.

In an embodiment, local hazard data having a value considered as being too low to supply an alarm signal does supply an alarm signal if received remote hazard data confirms the presence of said hazard.

According to a second aspect of the present invention, there is provided a method of alerting operatives as to the presence of a hazard, comprising the steps of: transferring local hazard data identifying levels of a potentially hazardous attribute from a detector mounted on an item of clothing worn by an operative to a control unit; receiving remote hazard data from one or more remote detectors mounted on remote items of clothing worn by respective remote operatives; and supplying an alarm signal from said control unit to a local alarm device in response to evaluating said local hazard data in combination with said remote hazard data.

In an embodiment, the method further comprises the steps of: generating local location data; receiving remote location data from said remote operatives; calculating distances to said remote operatives; and evaluating said remote hazard data with reference to said calculated distances. The remote hazard data may each be weighted by a respective calculated distance.

### BRIEF DESCRIPTION OF THE SEVERAL VIEWS OF THE DRAWINGS

Embodiments of the invention will be described, by way of example only, with reference to the accompanying drawings. The detailed embodiments show the best mode known to the inventor and provide support for the invention as claimed. However, they are only exemplary and should not be used to interpret or limit the scope of the claims. Their purpose is to provide a teaching to those skilled in the art. Components and processes distinguished by ordinal phrases such as “first” and “second” do not necessarily define an order or ranking of any sort. In the drawings:

FIG. 1 shows operatives working in a hazardous environment;

FIG. 2 shows a jacket of the type identified in FIG. 1;

FIG. 3 shows a schematic representation of apparatus included within the jacket shown in FIG. 2:

FIG. 4 shows the connection of a detector to a loom of the type identified in FIG. 3;

FIG. 5 shows a peripheral device connector of the type identified in

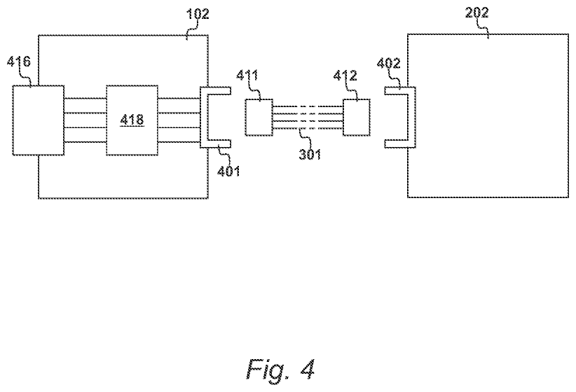

FIG. 4;

FIG. 6 details a portion of the loom identified in FIG. 4;

FIG. 7 shows a cross section of the loom portion shown in FIG. 6;

FIG. 8 shows an alternative wearable item with a peripheral device connector;

FIG. 9 shows the wearable item of FIG. 8 with a control unit attached to the peripheral device connector;

FIG. 10 shows a schematic representation of the control unit identified in FIG. 9;

FIG. 11 shows a system for alerting operatives, including a base station;

FIG. 12 illustrates operations performed by the control unit identified in FIG. 9, including an evaluation step;

FIG. 13 details the evaluation step identified in FIG. 12;

FIG. 14 illustrates the comparing of hazard data against thresholds;

FIG. 15 shows alternative operations performed by the control unit identified in FIG. 9, including the processing of location data; and

FIG. 16 shows operations performed by the base station identified in FIG. 11.

### DETAILED DESCRIPTION OF EMBODIMENTS OF THE INVENTION

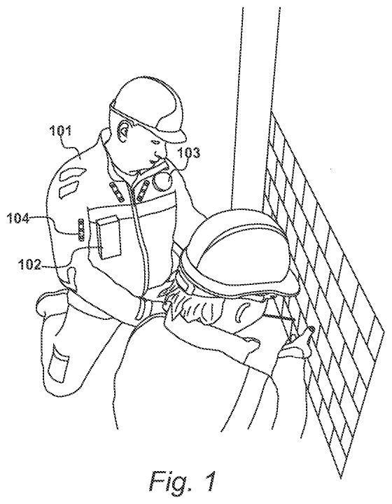

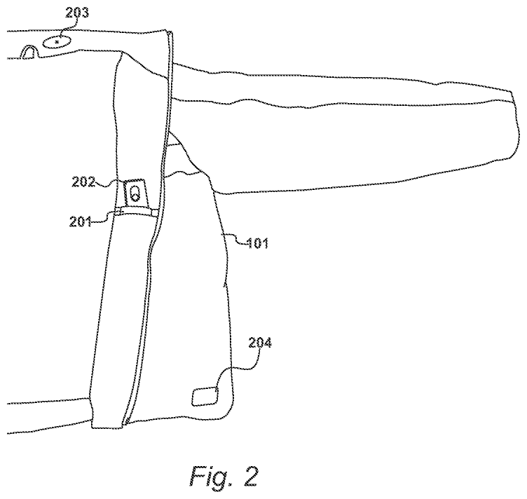

### FIG. 1

Operatives are shown in FIG. 1 working in a hazardous environment. Each operative wears an item of clothing, such as a jacket 101, that includes apparatus for the detection of hazards, such that alert signals and alarm signals may be produced. The apparatus includes a control unit and, in the example shown in FIG. 1, the control unit is retained within an internal pocket, as detailed with reference to FIG. 2.

The apparatus includes a hazard detector 102 and an alarm device 103. Within the jacket 101, there is also an embedded wiring loom forming part of an apparatus for transferring local hazard data from the hazard detector 102 to the control unit and for conveying alarm signals to the alarm device 103. The control unit is also configured to receive remote hazard data from one or more remote locations and supply alarm signals to the alarm device in response to evaluating the local hazard data in combination with the remote hazard data.

In an embodiment, the alarm device 103 generates an audible alarm signal. In addition, in this embodiment, the jacket 101 also includes light-emitting devices 104 connected to the loom. These light-emitting devices 104 may be configured to respond to alarm signals by flashing in a particular color. Thus, in an embodiment, the production of an alarm signal may result in light-emitting devices flashing in red. In an embodiment, the light emitting devices may be illuminated in white to enhance the visibility of the operative. Furthermore, in an embodiment, an alert signal may be generated and an alert condition may be conveyed locally to an operative by flashing the light emitting devices 104 in amber. Thus, an amber alert condition may be used to request an operative to investigate a local hazardous condition, such as a local gas leak for example. If the alert condition then escalates to a red alarm condition, the operative may be required to evacuate the environment.

For the purposes of this example, it may be assumed that the hazard detector 102 is configured to detect concentrations of dust particles. It is appreciated that relatively high concentrations of dust particles create hazards that require immediate action to be taken. However, it is also noted that hazards are created by relatively low levels of dust that remain in the atmosphere for significant periods of time. Thus, a significant hazard exists, which can easily be missed, relating to overall exposure to dust that needs to be evaluated and, where appropriate, invoking measures to mitigate the generation of this dust.

Thus, it is appreciated that dust may be generated locally and, for short intervals, operatives may be in a position to take appropriate action, deploying mask etc. Under these conditions, an alarm signal is not necessary and such a condition may be identified as a false positive that may cause unnecessary disruption. In addition, a relatively low level of dust may fall below a local threshold. However, the presence of this dust may be relatively widespread and although missed by each individual apparatus, collectively creates a hazard for which action is required. Thus, a condition of this type may be identified as a false negative.

It has also been appreciated that the widespread distribution of dust may occur periodically; possibly due to the movement of vehicles. To mitigate the unnecessary distribution of dust in this way, it is known to deploy water spraying equipment, thereby ensuring that the potential dust particles remain at ground level.

In an embodiment, described with reference to FIG. 16, a base station may be configured to analyse received alarm data in order to predict when it is likely that a hazardous condition will be generated, such as the generation of atmospheric dust due to the movement of vehicles. The embodiment then produces a schedule of concern such that, in anticipation of dust (or another hazard) being created, appropriate action, such as the spraying of water, is arranged to take place.

### FIG. 2

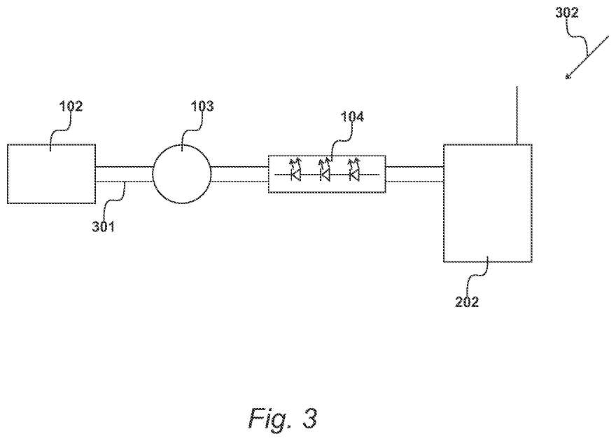

Jacket 101 is detailed in FIG. 2. An internal pocket 201 is provided in the jacket 101 for receiving a control unit 202. In use, the control unit 202 is connected to the loom, as described in reference to FIG. 3 and the control unit is disconnected from this loom at the end of each shift, so that the control unit may be recharged and, possibly, receive new instructions.

In an embodiment, the jacket 101 also includes a microphone 203 connected to the loom, thereby allowing an operative to communicate with a base station. In embodiment, the jacket 101 also includes an identification tag 204.

### FIG. 3

A schematic representation of the apparatus included within the jacket 101, an example of a wearable item, is shown in FIG. 3. The control unit 202, the hazard detector 102, the audio alarm device 103 and the light emitting devices 104 are each connected to a loom 301. Details of an embodiment of the loom 301 will be described with reference to FIG. 6

As indicated by arrow 302, the control unit 202 receives remote hazard data from one or more remote locations and is then configured to supply an alarm signal to the alarm device 103 in response to evaluating the local hazard data, received from the local hazard detector 102, in combination with remote hazard data received from other operatives.

### FIG. 4

The wearable item shown in FIG. 1 is a jacket but other items of clothing may be deployed, usually of the type worn on the upper torso. Thus, the wearable item may take the form of a vest or a tabard etc.

Light emitting devices 104 connected to the loom are configured to be illuminated in response to power and data received from the control unit 202 as described in U.S. Pat. No. 10,161,611 assigned to the present applicant. The loom 301 connects the light emitting devices and peripheral devices (including the hazard detector 102 and the alarm device 103) to the control unit by means of loom connectors 401. The control unit 202 also includes a similar loom connector 402.

In an embodiment, the loom consists of a first conductor and a second conductor twisted together to form a first twisted pair. In addition, a third conductor and a fourth conductor are twisted together to form a second twisted pair and a woven material surrounds the first twisted pair and the second twisted pair. In addition, stitches are provided between the first twisted pair and the second twisted pair to form a first conduit for the first twisted pair and a second conduit for the second twisted pair, as described with reference to FIG. 7.

In an embodiment, the control unit 202 is configured to convey electrical energy over the first twisted pair and data signals over the second twisted pair to the light emitting devices 104, the hazard detector 102 and the alarm device 103. As previously described, the light emitting devices may emit light of different colors and the color of this light is controlled in response to data signals received from the control unit 202.

Many types of hazard detector may be deployed, with many sensors of this type becoming available at substantially reduced costs by the deployment of micro-electrical-mechanical systems (MEMS). This facilitates the deployment of substantially more detectors of this type within a particular environment. Hazard sensors are available for producing hazard data in response to detecting hazards that non-exclusively include gas, radiation, dust particles, sound, proximity to vehicles and proximity to other operatives.

In an embodiment, the conducting cables of the loom 301 are connected to peripheral device connectors, including a first peripheral device connector 411 and a second peripheral device connector 412. Data transmission occurs over the loom in accordance with a loom protocol. The loom protocol is based around established I squared C protocols and facilitates the generation of data for activating LED devices, such as devices 104.

In an alternative embodiment, the control unit 202 is connected externally to the loom by means of loom connector 402 that attaches to peripheral device connector 412. The hazard detector 102 has a hazard sensing device 416, loom connector 401 and an interface circuit 418.

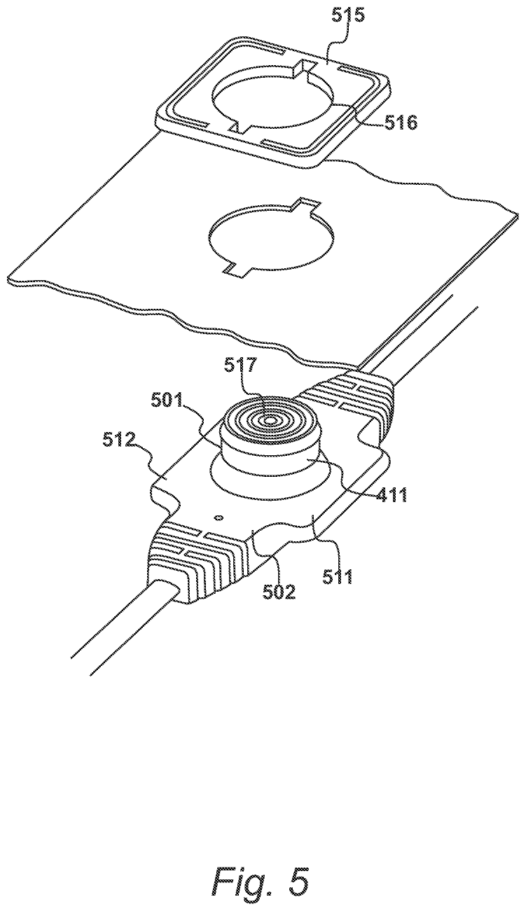

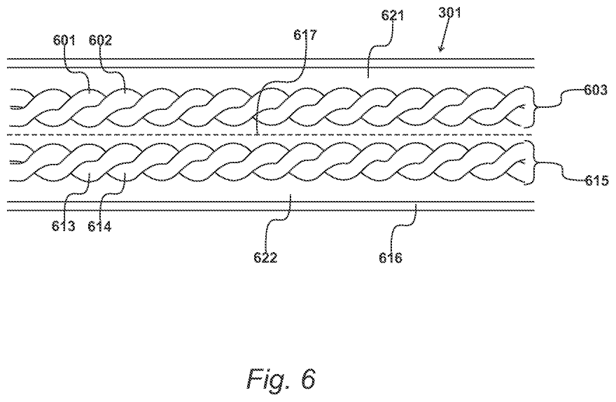

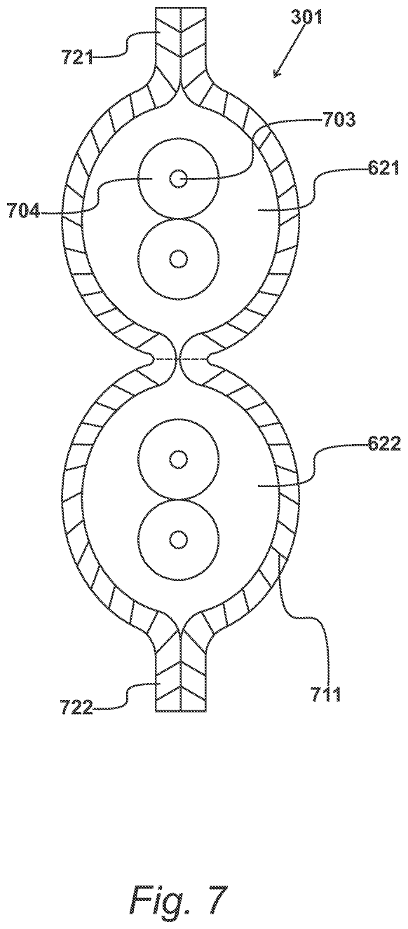

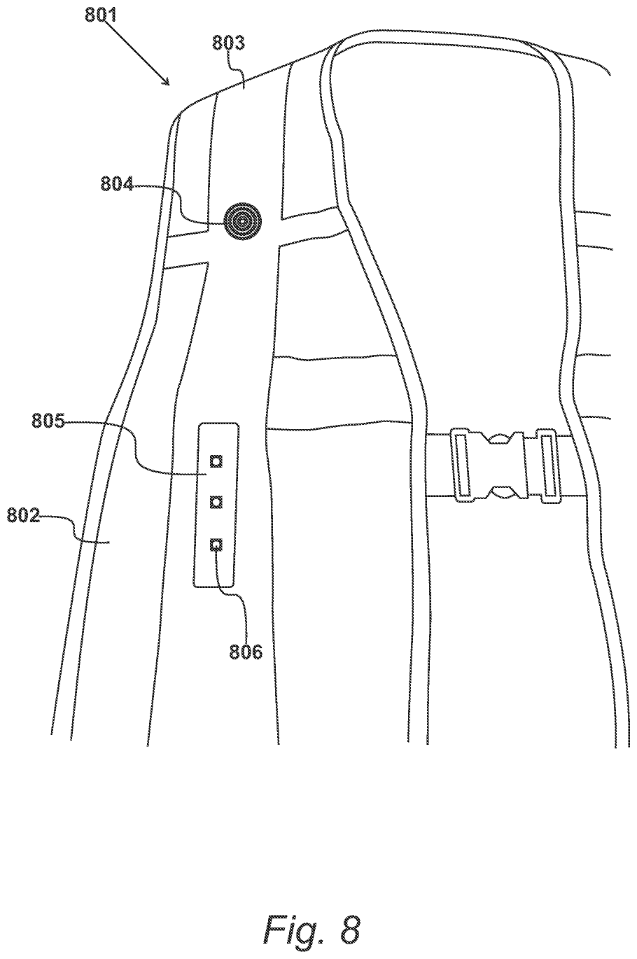

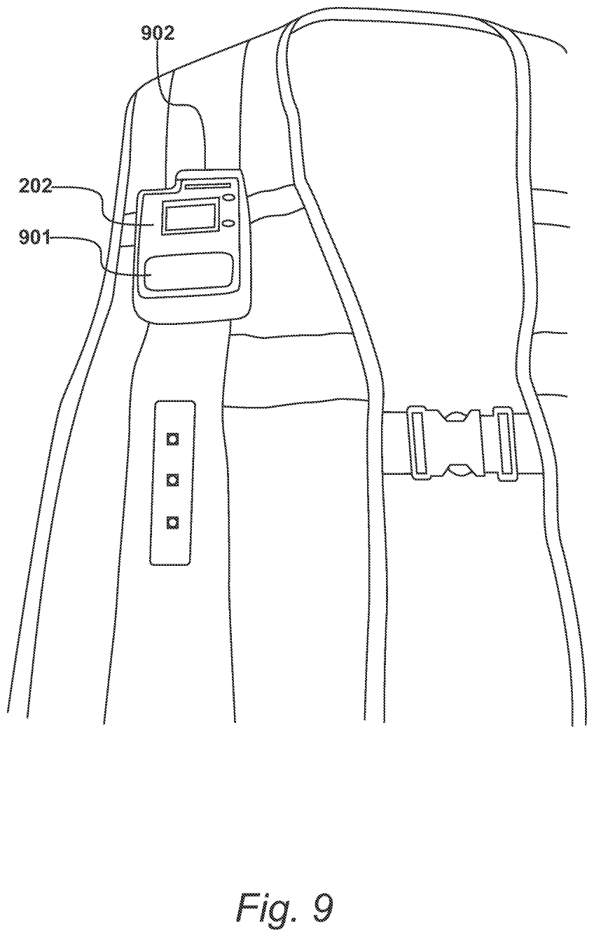

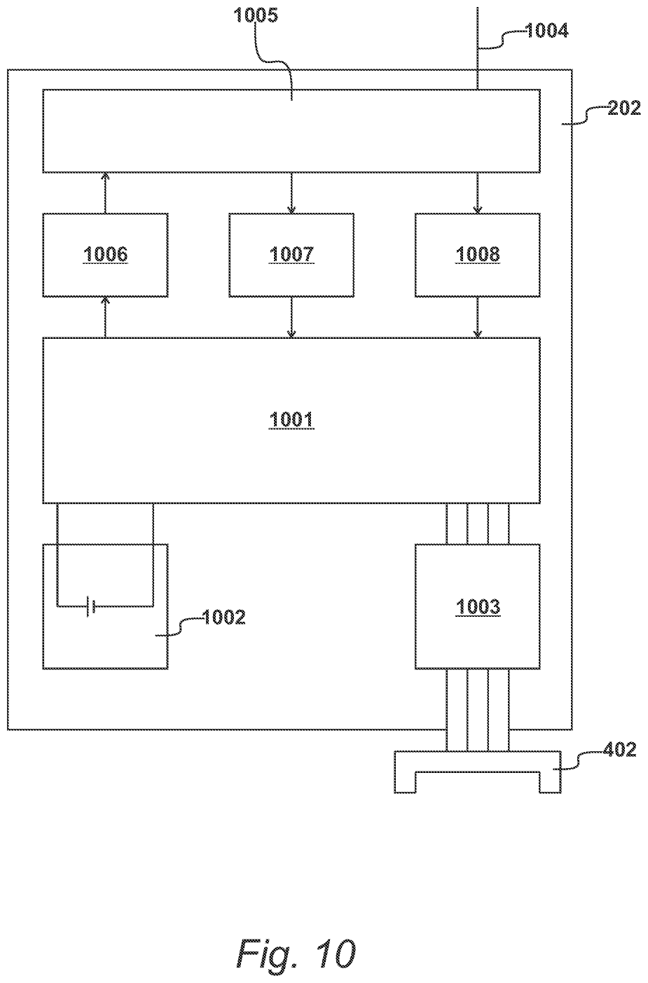

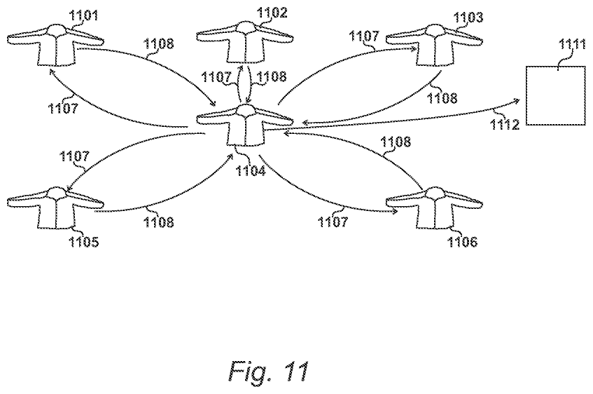

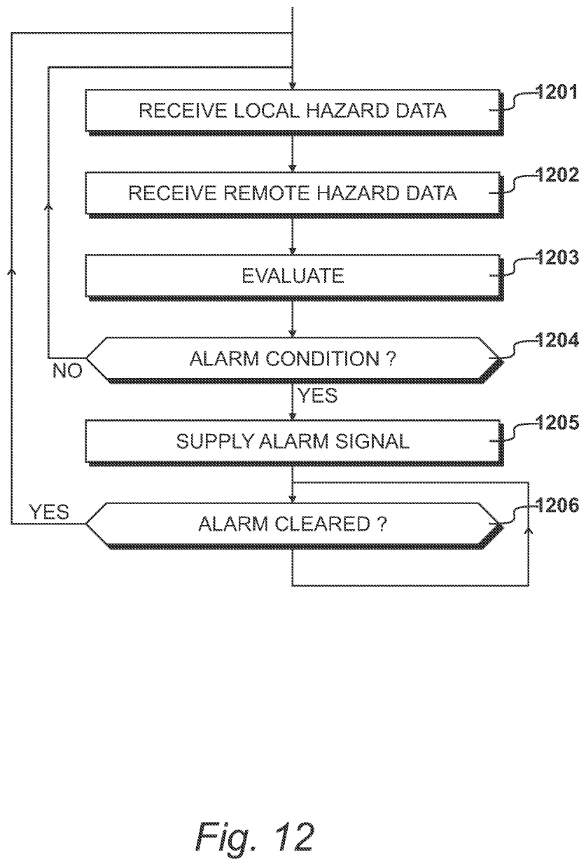

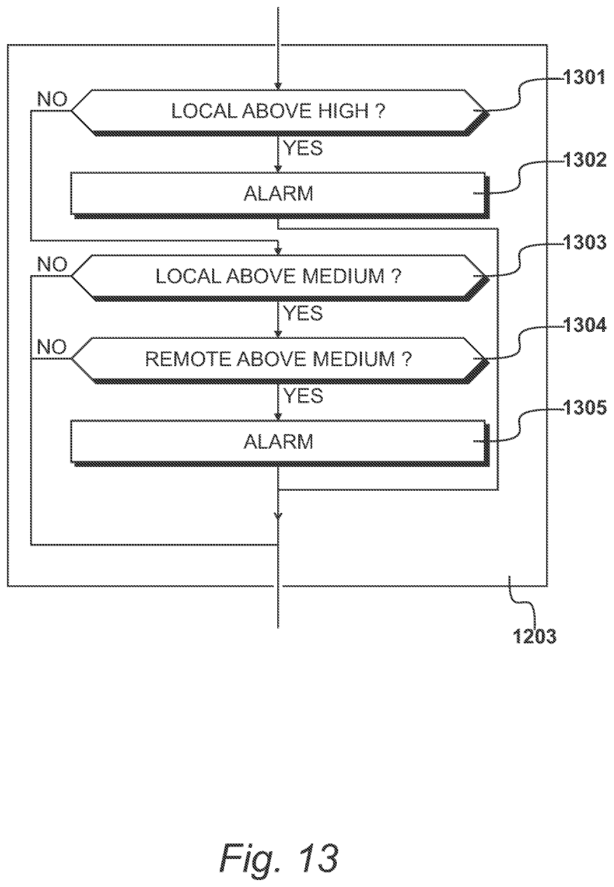

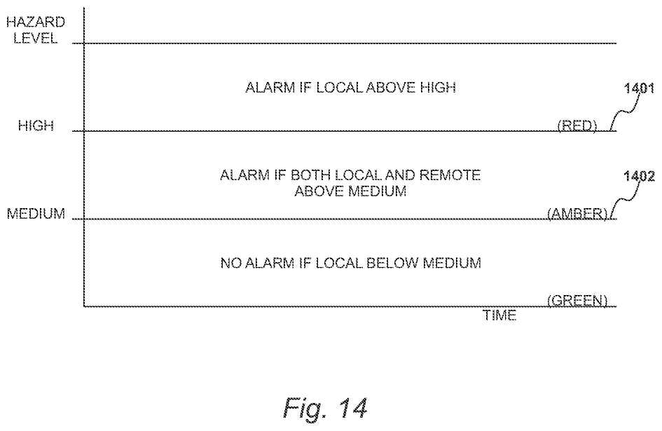

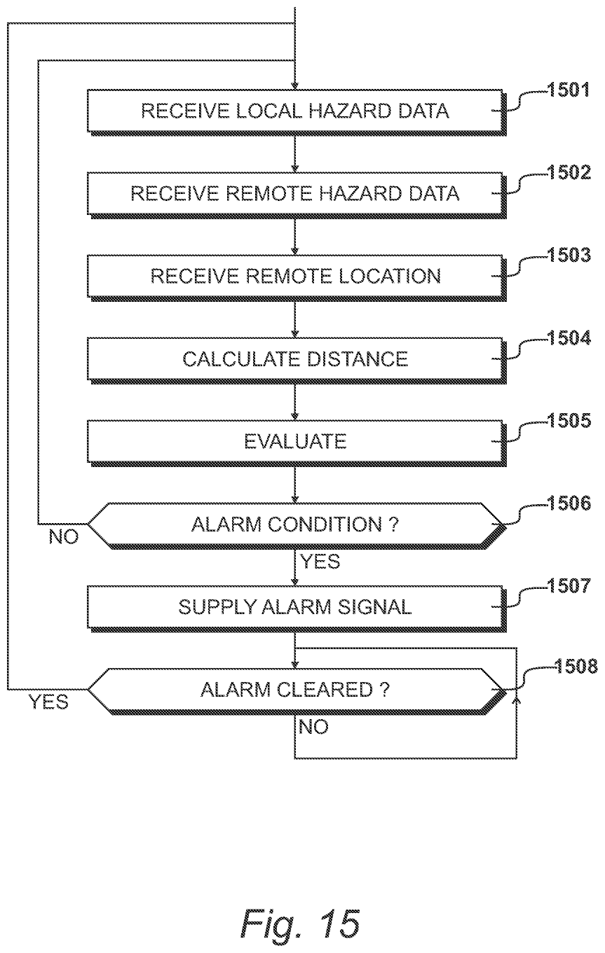

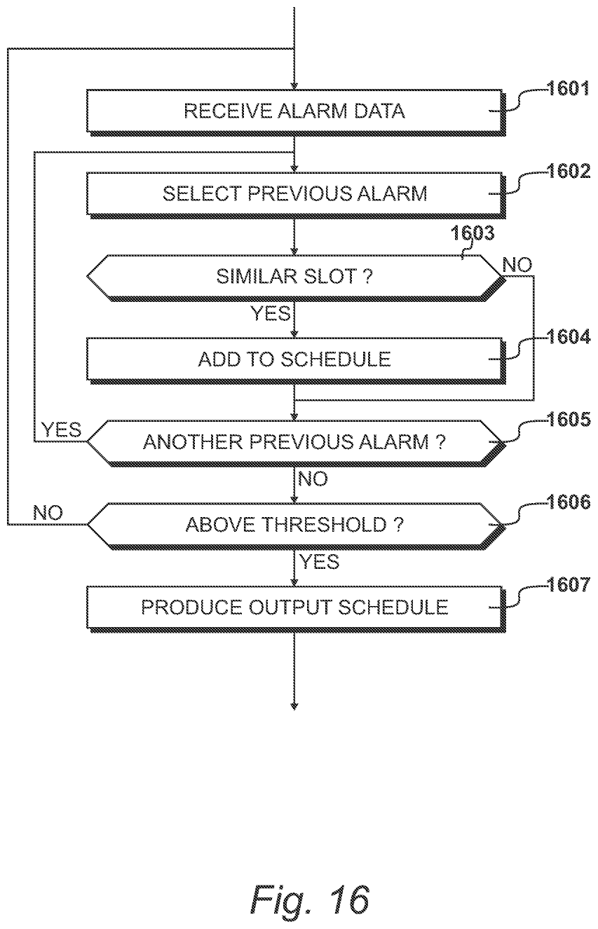

### FIG. 5

Peripheral device connector 411 is detailed in FIG. 5. The connector extends through an orifice 501 of an over moulded rubber cover 502. The cover 502 includes a first side flange 511 and a second side flange 512, to facilitate attachment to a wearable item, as described in U.S. Pat. No. 10,881,156 assigned to the present applicant.

In an embodiment, an outer cover 515 is also provided that includes a similar orifice 516. The peripheral device connector presents a circular surface 517 that lies substantially parallel with the outer surface of the wearable item. The circular surface includes a plurality of concentric electrical connectors to provide electrical connection to loom connectors, such as connector 401.

### FIG. 6

A portion of the loom 301 is shown in FIG. 6. A first conductor 601 and a second conductor 602 are twisted together to form a first twisted pair 603. In addition, a third conductor 613 and a fourth conductor 614 form a second twisted pair 615. A woven material 616 surrounds the first twisted pair 603 and the second twisted pair 615.

A line of stitching 617 is supplied between the first twisted pair 603 and the second twisted pair 615. This ensures that the two twisted pairs are separated and retained within their own respective conduits. Thus, the inclusion of stitching 617 results in the creation of a first conduit 621 and a second conduit 622.

### FIG. 7

A cross section of the loom portion 301 is shown in FIG. 7. The first twisted pair is held within the first conduit 621 and the second twisted pair is held within the second conduit 622. Each conductor, such as the first conductor 601, includes a conducting inner core 703 and a surrounding insulator 704. In an embodiment, the surrounding insulator 704 is formed from a silicone rubber that is capable of being washed at relatively high temperatures, typically above 80° C.

The woven material 616 allows a degree of flexibility to facilitate deployment of the loom within a wearable item. However, it is also resilient to ensure that the cables contained therein cannot penetrate the outer surface of the loom. Furthermore, it is difficult for the cables to form loops, which could create positions of weakness and failure

In an embodiment, the fabric material 616 includes electrically conductive threads 711 to facilitate deployment within environments that may include explosive gases.

The woven material is brought together at each end to form a first securing tab 721 and a second securing tab 722. These securing tabs allow the loom to be secured, possibly by stitching, to the wearable item. One of the securing tabs may be color-coded to distinguish the two twisted pairs.

### FIG. 8

As an alternative to the control unit 202 being retained within an internal pocket, it is possible for the control unit to be mounted externally.

A wearable item in the form of a vest 801 is shown in FIG. 8. The vest is constructed from fluorescent material 802 with light-reflecting strips, including light-reflecting strip 803. A peripheral device connector 804 extends from light-reflecting strip 803, with the twisted pairs of the loom 301 being retained behind the light-reflecting strip 803. In this embodiment, a subassembly 805 of light emitting devices 806 is also attached to the light-reflecting strip 803 is and electrically connected to the loom 301.

### FIG. 9

In FIG. 9, the control unit 202 is shown connected to the peripheral device connector 804. In this configuration, an operative can activate the control unit by depressing a large control button 901 and an operative can view output indications provided by light emitting diodes contained behind a transparent enclosure 902.

### FIG. 10

An example of a control unit 201 is detailed in FIG. 10, with its loom connector 402. The control unit 202 includes a microcontroller 1001 that includes internal memory for storing executable instructions. The microcontroller 1001 receives power from an internal rechargeable battery 1002 and, as previously described, the control unit 202 may be removed from the loom for recharging purposes.

An interface circuit 1003 connects the microcontroller to the external loom connector 402. The microcontroller 1001 supplies data to the loom and receives data from the loom via the interface circuit 1003. Furthermore, the interface circuit 1003 also facilitates the transmission of power to the loom, for powering peripheral devices, from the battery 1002.

An aerial 1004 (which may be restrained internally within the casing of the control unit) communicates with internal systems via a radio multiplexer 1005. Radio transmissions are made via a radio transmitter 1006 and received via a radio receiver 1007. In addition, radio data is received from which a location evaluation device 1008 (such as a GPS device) supplies positional data to the microcontroller 1001.

The radio receiver 1007 allows the control unit to receive hazard data from one or more remote locations. In response to this, it is possible for the microcontroller to supply an alarm signal to the alarm device in response to evaluating the local hazard data in combination with the remote hazard data. The radio transmitter 1006 facilitates the transmission of local hazard data to other remote apparatus. Thus, when local hazard data is transmitted it is then received as remote hazard data.

In addition to receiving local location data, in an embodiment, the microcontroller 1001 also transmits this location data, via the radio transmitter 1006 so that it may be received by other operatives. Thus, when received, this location data is considered as remote location data. Thus, in an embodiment, the microcontroller 1001 also receives remote location data. Using this, it is possible for the microcontroller to calculate distances to remote locations by comparing received remote location data with generated local location data. The control unit may then be configured to modify the remote hazard data in response to a respective calculated distance.

### FIG. 11

A system is shown in FIG. 11 for alerting operatives as to the presence of a hazard. The system includes many wearable items, of which six are shown in FIG. 11 identified as 1101 to 1106. In an operational environment, each wearable item 1101 to 1106 is worn by a respective operative.

Each wearable item includes a detector, as described with reference to FIG. 3, for detecting the presence of a hazardous attribute, in addition to a control unit for receiving local hazard data from the detector and an alarm device for conveying an alarm condition to the respective operative. As described with reference to FIG. 10, each item includes a transmitter for transmitting the local hazard data to other operatives within the operational vicinity.

In the embodiment of FIG. 11, the fourth wearable item 1104 is shown transmitting data to the other operatives, as indicated by transmission arrows 1107. This transmitted local hazard data is received by each of the other operatives as remote hazard data. A receiver, such as receiver 1007, receives this remote hazard data, transmitted from the other operatives, as indicated by arrows 1108. However, it should be appreciated that these two-way transmissions take place between all possible pairings of operatives within the environment. In this way, each control unit is configured to supply an alarm signal to its local alarm device in response to evaluating the local hazard data in combination with received remote hazard data.

The system of FIG. 11 also includes a base station 1111. Control units are configured to transmit data to the base station 1111 as indicated by arrow 1112. Periodically, hazard data may be transmitted to the base station. In addition, alarm conditions, when they occur, may also be transmitted to the base station 1111. This allows the base station 1111 to evaluate alarm conditions and possibly make predictions, as described with reference to FIG. 16.

### FIG. 12

To enable the system described with reference to FIG. 11 to function, instructions are executed by the microcontroller 1001, as illustrated in FIG. 12.

At step 1201, local hazard data is received and at step 1202 remote hazard data is received. At step 1203, an evaluation is made based on the local hazard data received at step 1201 in combination with the remote hazard data received at step 1202.

At step 1204, a question is asked as to whether an alarm condition has been identified and when answered in the affirmative, an alarm signal is supplied to the alarm device at step 1205. In response to an alarm signal being generated, operatives working in the environment take appropriate action, which may involve evacuating the area until the alarm condition has been cleared. Thus, a question is asked at step 1206 as to whether the alarm condition has been cleared and when answered in the affirmative, control is returned to step 1201. Control is also returned to step 1201 if the question asked at step 1204 is answered in the negative.

### FIG. 13

An example of procedures 1203 for evaluating hazard data are detailed in FIG. 13. In this embodiment, thresholds have been established representing a high level of hazard and a medium level of hazard. In this embodiment, if a high level of hazard, such as a high concentration of dust particles, is identified locally, this will trigger an alarm condition irrespective of data received from remote locations. Thus, at step 1301 a question is asked as to whether the hazard level is above the high threshold and when answered in the affirmative, an alarm condition is activated at step 1302.

If the question asked at step 1301 is answered in the negative, to the effect that the hazard level is below the high threshold, a question is asked at step 1303 as to whether the level is above a medium threshold. If answered in the negative, control is directed to step 1204 and no further action is taken.

If the question asked at step 1303 is answered in the affirmative, a question is asked step 1304 as to whether remote levels are above the medium threshold. If answered in the affirmative, an alarm condition is established at step 1305, resulting in the question asked at step 1204 being answered in the affirmative.

### FIG. 14

The effect of the procedure described with reference to FIG. 13 being implemented is illustrated in FIG. 14. When the local hazard data has a level that is higher than the high threshold 1401, this may be considered as a red condition, resulting in the generation of a red local alarm. Thus, the audio alarm device 103 may produce an audio output and the light emitting devices 104 may flash red.

If the high level is set too low, this may result in the generation of false positive alarm signals. Similarly, if the level is too high, hazardous ambient levels may be missed. The embodiment therefore provides a medium hazard level 1402. In response to a local detection above the medium level 1402 but below the high level 1401, the generation of an alarm signal is suppressed. However, in an embodiment, an amber alert may be generated, resulting in devices 104 flashing amber to the local operative.

However, as described with reference to FIG. 13, if remote hazard data levels are also above the medium threshold 1402, this may indicate a wide ambient distribution of the hazard, resulting in potential exposure for significant periods of time. Consequently, if remote levels are also above this medium threshold, the question asked at step 1304 is also answered in the affirmative and the alarm condition is raised at step 1305.

Thus, in an embodiment, an alert condition is generated in response to a local detection, possibly due to a short-term leak, whereas an alarm condition is raised if local hazard detection is made and remote hazard detection is also made.

### FIG. 15

In an embodiment, the microcontroller 1010 is also configured to generate location data. In addition, remote location data is received from the remote operatives. From this, distances to the remote operatives are calculated and the evaluation of the remote hazard data is made with reference to these calculated distances.

At step 1501, local hazard data is received and at step 1502 remote hazard data is received. At step 1503, remote location data is received and, for each remote location, a distance to that location is calculated at step 1504.

An evaluation is made at step 1505 and a question is then asked at step 1506 as to whether alarm condition exists. When answered in the affirmative, an alarm signal is supplied at step 1507 and at step 1508, a question is asked as to whether the alarm condition has been cleared. Thus, when the question asked at step 1508 is answered in the affirmative, control is returned to step 1501. Control is also returned to step 1501 if the question asked at step 1506 is answered in the negative.

In an embodiment, each remote hazard data level may be weighted with respect to the distance calculated at step 1504. As shown in FIG. 1, two operatives are working relatively closely together. It is therefore likely that if a local hazard condition is generated, possibly due to the local generation of noise, gas or dust, both operatives will register the same event.

Remote location data is received by the first operative from the second operative. The control unit on the first operative calculates the distance to the second operative. This distance is used to modify the importance of the remote hazard data received from the second operative. The remote hazard data is therefore modified or weighted prior to being evaluated. In an embodiment, the level of the hazard data may be multiplied by the distance, thereby giving a greater weight to remote data received from operatives working further away. This condition indicates that an overall ambient hazard exists which in turn, according to an embodiment, is more likely to generate an alarm condition.

Thus, in an embodiment, it is possible to suppress the supply the local hazard-based alarm signal if the remote hazard data indicates relatively low hazard levels or if the remote data originates from a location that is close.

Alternatively, in an embodiment, an alarm signal is supplied in response to a relatively low local level if the remote hazard data confirms the presence of the hazard and, in particular, if the remote hazard data is coming from operatives that are displaced some distance away.

### FIG. 16

As previously described with reference to FIG. 11, an embodiment transmits the local hazard data and locally generated alarm signal related data to the base station 1111.

At the base station, an embodiment analyses received hazard data and received alarm data. The base station is then configured to identify repeating patterns of received alarm data.

Procedures performed at the base station 1111 are shown in FIG. 16. At step 1601, alarm data is received and at step 1602, previous alarm conditions are selected from a history of similar events, possibly read from a database. At step 1603, a question is asked as to whether these alarm conditions exist within a similar time slot. If answered in the affirmative, this relationship is added to a schedule of alarm conditions at step 1604.

At step 1605, a question is asked as to whether another previous alarm condition is present within the database, resulting in this alarm condition being selected at step 1602 and the question at step 1603 being asked again; as to whether they occur in a similar time slot. Thus, again, if answered in the affirmative, the condition is added to a schedule of alarms at step 1604.

Eventually, all previous alarm conditions will have been considered, resulting in the question asked step 1605 being as negative.

At step 1606, a number of alarm conditions may have been added to the schedule. A question is then asked at step 1606 as to whether this number exceeds a predetermined threshold. Thus, in an embodiment, two occurrences within similar timeslots may be interpreted as a coincidence but if three or more are identified in a similar time slot, this may be interpreted as a recurring hazard for which pre-emptive action may take place.

Thus, if the question asked at step 1606 is answered in the affirmative, to the effect that three or more alarm events have been identified as occurring within similar timeslots, an output schedule is produced at step 1607.

In terms of alarm events occurring within similar timeslots, a working week may be appropriately divided. Thus, a working day could be divided into ten timeslots, such that a total of fifty timeslots are considered within a working week. Thus, it may be noticed that delivery trucks arrive between 10 am and 11 am each Monday morning and often generate unacceptable levels of ambient dust. This may be identified as a repeating pattern of received alarm data. This condition is identified on an output schedule which, in addition to identifying the occurrence of the repeating hazard, may also specify alarm avoidance activities. Thus, in an embodiment, a water spraying schedule may be identified as an alarm avoidance activity and automated water spraying may take place in anticipation of delivery lorries arriving.

What we claim is:

1. A system for alerting operatives as to the presence of a hazard, comprising a plurality of wearable items, wherein each said wearable item is worn by a respective operative and each said wearable item comprises:
a detector for detecting the presence of a hazardous attribute;
a control unit for receiving local hazard data from said detector;
an alarm device for conveying an alarm condition to said respective operative;
a transmitter for transmitting said local hazard data to other operatives within an operational vicinity, where said local hazard data is received as remote hazard data; and
a receiver for receiving remote hazard data transmitted from said other operatives, wherein:
said control unit is configured to supply an alarm signal to said alarm device in response to evaluating said local hazard data in combination with said remote hazard data.

2. The system of claim 1, wherein:
each said wearable item comprises a location device for generating local location data;
said transmitter is configured to transmit said local location data to said other operatives, where said local location data is received as remote location data;
said receiver is configured to receive remote location data transmitted from said other operatives;
said control unit is configured to calculate distances to said other operatives based on said local location data and said remote location data; and
said control unit is configured to evaluate said remote hazard data with reference to said calculated distances.

3. The system of claim 2, wherein said remote hazard data are each weighted by a respective calculated distance.

4. The system of claim 1, wherein a potential alarm signal based on a local hazardous attribute is supressed when said remote hazard data indicates levels below a predetermined threshold.

5. The system of claim 1, wherein local hazard data having a value considered as being too low to supply an alarm signal does supply an alarm signal when said remote hazard data confirms the presence of said hazard.

6. The system of claim 1, wherein said transmitter is configured to transmit said local hazard data and alarm data, indicating the supply of said alarm signal, to a base station.

7. The system of claim 6, wherein said base station is configured to analyze received hazard data and received alarm data to identify repeating patterns of alarm conditions.

8. The system of claim 7, wherein said base station is configured to produce a concern schedule identifying the presence of repeating alarm conditions.

9. The system of claim 8, wherein said concern schedule identifies alarm-avoidance activities.

10. The system of claim 9, wherein said received hazard data represents particle concentrations and said alarm-avoidance activities comprise time-specified water spraying to reduce a level of said particle concentrations.

11. A method of alerting operatives as to the presence of a hazard, comprising the steps of:
transferring local hazard data identifying levels of a potentially hazardous attribute from a detector mounted on an item of clothing worn by an operative to a control unit;
receiving remote hazard data from one or more remote detectors mounted on remote items of clothing worn by respective remote operatives; and
supplying an alarm signal from said control unit to a local alarm device in response to evaluating said local hazard data in combination with said remote hazard data.

12. The method of claim 11, further comprising the steps of:
generating local location data;
receiving remote location data from said remote operatives;
calculating distances to said remote operatives; and
evaluating said remote hazard data with reference to said calculated distances.

13. The method of claim 12, wherein said remote hazard data are each weighted by a respective calculated distance.

14. The method of claim 11, further comprising the step of supressing the supply of a local hazard-based alarm signal if said remote hazard data indicates hazard levels below a predetermined threshold.

15. The method of claim 11, further comprising the step of supplying an alarm signal in response to a relatively low level indicated by said local hazard data if said remote hazard data confirms the presence of said hazard.

16. The method of claim 11, further comprising the step of transmitting locally generated alarm signal related data to a base station.

17. The method of claim 16, further comprising the steps:
analysing received alarm data; and
identifying repeating patterns of said received alarm data.

18. The method of claim 17, further comprising the step of producing a concern schedule identifying the presence of repeating alarm conditions.

19. The method of claim 18, further comprising the step of identifying alarm-avoidance activities.

20. The method of claim 19, wherein a water spraying schedule is identified as an alarm-avoidance activity.
